(19) United States
(12) Patent Application Publication
(10) Pub. No.: US 2005/0185399 A1
(43) Pub. Date: Aug. 25, 2005

(54) Colored light for passengers of a passenger transportation means, in particular for the cabin of an aircraft

(75) Inventors: Franz-Josef Beermann, Warstein (DE); Ulrich Scheithauer, Erwitte (DE); Rolf Broelemann, Salzkotten (DE); Bernhard Mueller, Arnsberg (DE); Carsten Geske, Oelde (DE); Frank Gronemeier, Boenen (DE); Rico Schulz, Rixbeck (DE); Steffen Roebke, Paderborn (DE)

Correspondence Address: BIRCH STEWART KOLASCH & BIRCH, PO BOX 747, FALLS CHURCH, VA, 22040-0747, US

(73) Assignee: Goodrich Hella Aerospace Lighting Systems GmbH, Lippstadt (DE)

(21) Appl. No.: 11/049,714

(22) Filed: Feb. 4, 2005

Related U.S. Application Data
(60) Provisional application No. 60/541,915, filed on Feb. 6, 2004.

(51) Int. Cl. F21V 9/00

(52) U.S. Cl. 362/231; 362/227; 362/800; 362/471; 362/488; 362/490; 362/545

(57) ABSTRACT

A colored light for the passengers of a passenger transportation means, in particular for the cabin of an aircraft, comprises a plurality of illuminating means, each emitting electromagnetic waves in a narrow-band wavelength range, wherein the wavelength ranges preferably do not overlap each other. Further, the colored light is provided with a drive unit for driving the illuminating means such that a soothing or stimulating effect on the passengers can be achieved via the color sensation of the human eye and the thus triggered (bio-) chemical processes in the body.

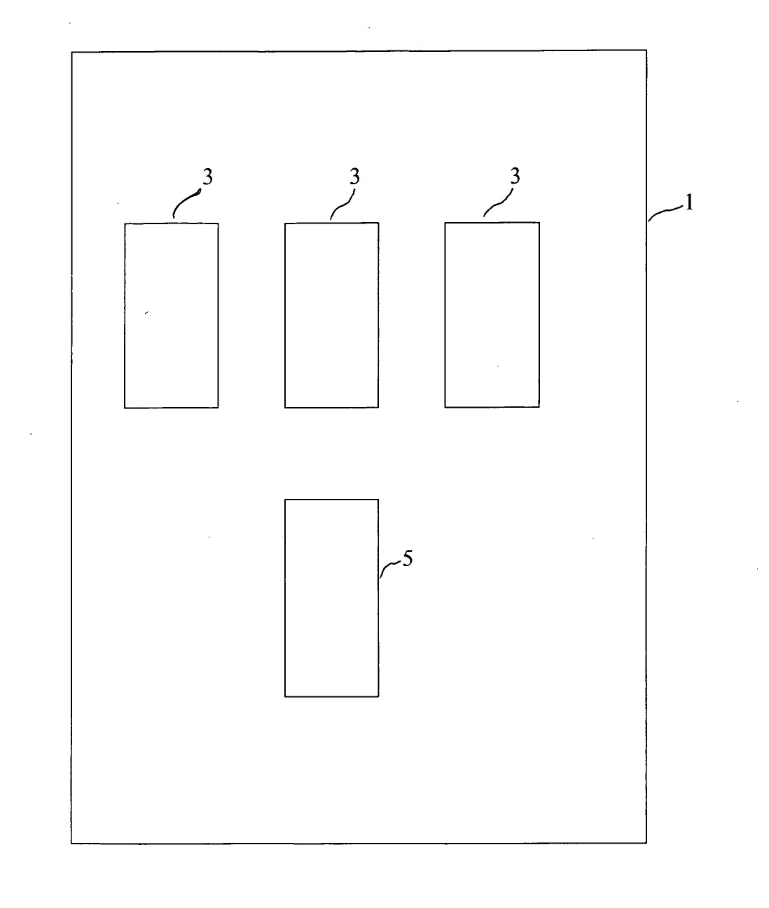

This nonprovisional application claims priority to Provisional Patent Application No. 60/541,915 filed in German on Feb. 6, 2004, which is herein incorporated by reference.

### BACKGROUND OF THE INVENTION

1. Field of the Invention

The invention relates to colored light for the passengers of a passenger transporter, in particular an aircraft. The colored light is used for illuminating the passenger room of the transporter, i.e., in the case of an aircraft for illuminating the cabin.

2. Description of Related Art

For creating a pleasant environment in rooms it is known to use colored light and also light changing in color (so-called mood light). It is known to produce such color effects by correspondingly driving RGB-illuminating devices. Suitable illuminating devices are in particular LEDs (Light Emitting Diodes).

### SUMMARY OF THE INVENTION

It is therefore an object of the invention to achieve an optimum color reproduction and an increase in the human color sensation by using colored illuminating devices having certain wavelengths and/or arrangements.

According to the invention, this object is solved by providing colored light for the passengers of a passenger transporter, in particular for the cabin of an aircraft, wherein the colored light is provided by:

a plurality of illuminating devices, each emitting electromagnetic waves in a narrow-band wavelength range, wherein the wavelength ranges preferably do not overlap each other, and

a drive unit for driving the illuminating devices such that a soothing or stimulating effect on the passengers can be achieved via a color sensation of a human eye and thus triggering (bio-) chemical processes in the body.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the drawing is a schematic illustration of an embodiment of the present invention.

### DETAILED DESCRIPTION OF THE INVENTION

The drawing shows a schematic illustration of an apparatus 1 for providing colored light for passengers of a passenger transporter. A plurality of illuminating devices 3 are provided that each emit electromagnetic waves in a narrow-band wavelength range, whereby the wavelength ranges do not overlap each other. The apparatus 1 further includes a drive unit 5 for driving the illuminating devices 3 so that a soothing and/or a stimulating effect on the passengers is achieved.

Thorough examinations have revealed that the human body can be influenced with regard to state of mind and well-being in a particularly effective manner by special frequencies/wavelengths of light impinging onto the body. The colored light according to the invention utilizes, in particular, this optimized process of conscious stimulation and/or conscious non-stimulation of the passengers.

The combination of particularly narrowband illuminating devices does not allow color temperatures, which result in a good color reproduction of illuminated objects, to be reached by overlapping wavelengths. In consideration of the mode of functioning of the receptors of the human eye and by adaptation to the color circle, it is possible to attain a very good color reproduction by selecting a few narrow-band illuminating devices, preferably light-emitting diodes. This color reproduction is attuned to the particular color sensation of the human eye and the (bio-) chemical processes triggered in the body by the color sensation, namely, for example, a soothing or stimulating effect exerted on the persons.

By using the illuminating devices emitting light in the narrow band, the human color sensation can be promoted. Besides illuminating devices emitting red, green and blue light, white light sources can additionally be employed which emit light in a small solid-angle range, as is, e. g., common in the case of LEDs, or in a larger solid-angle range. Within the meaning of the present invention, an illuminating device emitting light of a spectral narrow band can be a light source, which emits light within a wavelength range of up to 20 nm, preferably up to 10 nm, and in particular up to 5 nm. An illuminating device emitting light of a spatial narrow band can be, for example, a light source which emits light in a solid-angle range of, for instance, up to 120°.

Advantageously, the illuminating devices include light sources arranged in groups, wherein the light sources of each group emit light of different wavelengths and/or in spectrally narrowband wavelength ranges. To these illuminating devices, advantageously, one or a plurality of white light-emitting light sources may be added. In this manner, certain wavelengths and/or wavelength ranges of white light are intensified and/or emphasized.

With the combination of illuminating devices emitting light in the spectral narrow band, as is the case with LEDs, it is not possible to attain, by superposition of the wavelengths, an emission, which allows a good color reproduction. In consideration of the physiology of the human eye and by adaptation to the definition of the color reproduction, it is surprisingly possible, in accordance with the present invention, to achieve a good color reproduction by selecting special illuminating devices, preferably LEDs, which also emit light of a spectral narrow band. According to a first version of the colored light according to the present invention, said colored light comprises blue light of 470 nm±0-10 nm, green light of 540 nm±0-10 nm, yellow light of 580 nm±0-10 nm, and red light of 615±0-10 nm. The wavelength ranges stated above preferably extend by ±0-5 nm, and in particular ±0-2.5 nm, about the respective center wavelengths. An optimized version of the colored light according to the present invention comprises blue light of 450 nm±0-5 nm and 470 nm±0-5 nm, green light of 450 nm±0-10 nm, yellow light of 580 nm±0-10 nm, and red light of 610 nm±0-5 nm and 625 nm±0-5 nm.

Besides the improved color reproduction according to the present invention, the physiology of the human being can be influenced by adding other special wavelengths. For example, by adding spectrally narrowband blue light in a wavelength range between 450 nm and 465 nm, the production of melatonin and thus sleep can be suppressed. The associated control of the waking-sleeping rhythm allows an active reduction of the effects of the time-lag syndrome (the so-called jet lag).

Illuminating devices within the meaning of the invention are, inter alia, devices, which emit, possibly at least partially, electromagnetic waves in the nonvisible wavelength range.

The narrow-band illuminating devices advantageously have the following peak wavelengths. In a basic version for adequate color reproduction and dynamic color gradients the peak wavelengths are 450 nm and 550 nm as well as 580 nm and 610 nm. The illuminating devices are arranged side by side in groups according to the wavelengths stated below:
(450 nm+550 nm)+(450 nm+550 nm)+580 nm+610 nm.

A version with optimized color reproduction and dynamic color gradients includes, in the order stated below, illuminating devices arranged in groups with the following peak wavelengths:
(450 nm+550 nm)+580 nm+(450 nm+550 nm)+610 nm+(450 nm+550 nm)+590 nm+(450 nm+550 nm)+620 nm.

A mood-light version with optimized color reproduction and additional wake-up light with dynamic color gradients can be realized by adding further wavelengths, which are smaller than 450 nm. By adding such wavelengths to the emitted light, corresponding control programs can initiate and support wakeup and activation phases with the aid of light. For example, blue light with a wavelength of 450 nm prevents the production of melatonin in the human body and thus suppresses sleep (to a limited degree). Control of the light, i.e., program start and run, can be carried out directly by the cabin crew or automatically in dependence on the respective “location” of the aircraft during the flight with the aid of corresponding position signals, for example according to GPS. In this manner, day and night phases can be simulated by corresponding coupling-in of light in the cabin. The same applies to the time control of doze-off and wakeup phases.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. An apparatus for providing a colored light for passengers of a passenger transporter, in particular for a cabin of an aircraft, comprising:
a plurality of illuminating devices, each emitting electromagnetic waves in a narrow-band wavelength range, wherein the wavelength ranges preferably do not overlap each other; and
a drive unit for driving the illuminating devices such that a soothing or stimulating effect on the passengers is achievable via the color sensation of the human eye and thus triggering bio and/or chemical processes in the body.

2. The apparatus according to claim 1, wherein the illuminating devices are arranged in a plurality of groups, with the illuminating devices of each group emitting light in different narrow-band wavelength ranges.

3. The apparatus according to claim 1, wherein the illuminating devices further comprise illuminating devices that emit light in a broad band, and in particular white light.

4. The apparatus according to claim 1, wherein the illuminating devices emit blue light of 470 nm±0-10 nm, green light of 540 nm±0-10 nm, yellow light of 580 nm±0-10 nm, and red light of 615 nm±0-10 nm.

5. The apparatus according to claim 1, wherein the illuminating devices emit blue light of 450 nm±0-5 nm and 470 nm±0-5 nm, green light of 540 nm±0-10 nm, yellow light of 580 nm±0-10 nm, and red light of 610 nm±0-5 nm and 625 nm±0-5 nm.

6. The apparatus according to claim 1, wherein the illuminating devices are LEDs.

7. The apparatus according to claim 1, wherein driving of the illuminating devices is based on a time of day at a respective location of the passenger transporter.

8. A method for providing a colored light to passengers of a passenger transporter, the method comprising:
emitting electromagnetic waves in a narrow-band wavelength range by a plurality of illuminating devices, the wavelength ranges of each of the plurality of illuminating devices not overlapping each other; and
driving the illuminating devices by a drive unit such that a soothing and/or a stimulating effect on the passengers is achieved by a color sensation of a human eye and thus triggering bio and/or chemical processes in the body.

9. The method according to claim 8, wherein the passenger transporter is an airplane.

10. The method according to claim 8, wherein the electromagnetic waves are emitted to a passenger compartment of an airplane.

11. The method according to claim 8, wherein the plurality of illuminating devices are light emitting diodes.
